(19) United States
(12) Patent Application Publication
(10) Pub. No.: US 2007/0072611 A1
(43) Pub. Date: Mar. 29, 2007

(54) Information for media independent handover

(76) Inventors: Peretz M. Feder, Englewood, NJ (US); Ajay Rajkumar, Morristown, NJ (US); Sampath Rangarajan, Bridgewater, NJ (US); Yousif M. Targali, Sayreville, NJ (US)

Correspondence Address: HARNESS, DICKEY & PIERCE, P.L.C., P.O. BOX 8910, RESTON, VA, 20195, US

(21) Appl. No.: 11/237,722

(22) Filed: Sep. 29, 2005

(51) Int. Cl. H04Q 7/20

(52) U.S. Cl. 455/436

(57) ABSTRACT

At least data link information generated at a medium access control layer or physical link information generated at a physical layer is used to send information to a media independent handover layer.

### BACKGROUND OF THE INVENTION

Currently, an IEEE 802.21 working group is developing a standard framework for enabling media independent handover (MIH) between various wireline and wireless access technologies such as 802.3/11/15/16, as well as those standardized by 3GPP (e.g., UMTS, HSDPA) and 3GPP2 (e.g., CDMA200 1x, EVDO).

Media independent handover will be enabled by an MIH entity or MIH function (hereinafter collectively the “MIH layer” or “MIH”) that resides on the mobile node (MN) or mobile as well as the network. At the network, the MIH layer may be distributed across more than one element. The mobile node is generally assumed to be a multi-mode node with support for more than one interface type between which a handover can take place.

The MIH layer will reside above the MAC layer (802.11 and 802.16) or as part of the MAC layer (3GPP, 3GPP2) at both the mobile node and the network (e.g., a base station). FIG. 1 illustrates an example of a conventional mobile node 3GPP with anticipated 802.21 compliant architecture that includes an MIH layer, and FIG. 2 illustrates an example of a conventional mobile node 3GPP2 with anticipated 802.21 compliant architecture that includes an MIH layer.

The MIH layer will receive “triggers” from the lower layers such as the media access control (MAC) layer and the physical (Phy or PHY) layer. The MIH layer may either pass these triggers to upper layers (e.g., the MM/SM layer in FIG. 1) or process these triggers and send “directives” or commands based on these triggers both to the upper and lower layers to enable seamless handover of a data session when the mobile moves from one access technology to another. In addition to receiving triggers and passing directives within the network and mobile node, respectively, the MIH on the base station and the mobile node can exchange these directives among themselves. The MIH layer on the network (possibly on the base station) can interface with a policy server, and information received from the policy server could be used by the MIH to determine handover directives (in addition to the use of lower layer triggers). Currently, the types of triggers and triggering events have not been established.

### SUMMARY OF THE INVENTION

According to the present invention, the 3GPP, 3GPP2, etc., architectures are modified to include a link from the medium access control (MAC) layer and the physical (PHY) layer to a secondary layer (e.g., RRC or LAC), and a link from the secondary layer to the media independent handover (MIH) layer. For example, the MAC and PHY layers each include a service access point (SAP) for communicating with the secondary layer and the secondary layer includes a SAP for communicating with the MIH. Alternatively, or additionally, the PHY and MAC layers each include a SAP for direct interface with the MIH.

In one embodiment, data link information is generated at the MAC layer and used to send information to the MIH layer. The data link information indicates one of data link state information and data link quality information. For example, the data link state information may indicate the data link is up, down, going down, etc. The data link quality information may indicate a bit-error rate of the data link, a packet-error rate of the data link, load conditions of the data link, etc. In another embodiment, physical link information is generated at the PHY layer and used to send information to the MIH layer. The physical link information indicates one of physical link state information and physical link quality information. For example, the physical link state information may indicate the physical link is up, down, going down, etc. The physical link quality information may indicate a signal strength of a received signal, a signal-to-noise ratio of a received signal, etc.

Furthermore, in other embodiments, the MIH layer may send information (e.g., triggers, directives, etc.) for providing a directive or trigger to at least one of a physical layer and a MAC layer.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates an example of a conventional mobile node 3GPP with anticipated 802.21 compliant architecture that includes an MIH layer;

FIG. 2 illustrates an example of a conventional mobile node 3GPP2 with anticipated 802.21 compliant architecture that includes an MIH layer;

FIG. 3 illustrates an example of the mobile node architecture of FIG. 1 that has been modified according to an embodiment of the present invention;

FIG. 4 illustrates an example of the mobile node architecture of FIG. 2 that has been modified according to an embodiment of the present invention;

FIG. 5 illustrates a state machine according to which the PPP layer of FIG. 3 or FIG. 4 operates according to an embodiment of the present invention to generate link level triggers that may be used by the MIH layer;

FIG. 6 illustrates another example of the mobile node architecture of FIG. 1 that has been modified according to an embodiment of the present invention; and

FIG. 7 illustrates another example of the mobile node architecture of FIG. 2 that has been modified according to an embodiment of the present invention.

### DETAILED DESCRIPTION OF EXAMPLE EMBODIMENTS

The present invention provides a number of triggers that may be sent to the media independent handover (MIH) layer to improve handover speed and performance. First, example 3GPP and 3GPP2 architecture modifications to support these new triggers will be described. Then, an embodiment of a state machine, employed by the point-to-point protocol (PPP) layer, to generate triggers for the MIH layer will be described. This will be followed by further example 3GPP and 3GPP2 architectures and triggers.

### Example 3GPP and 3GPP2 Architectures

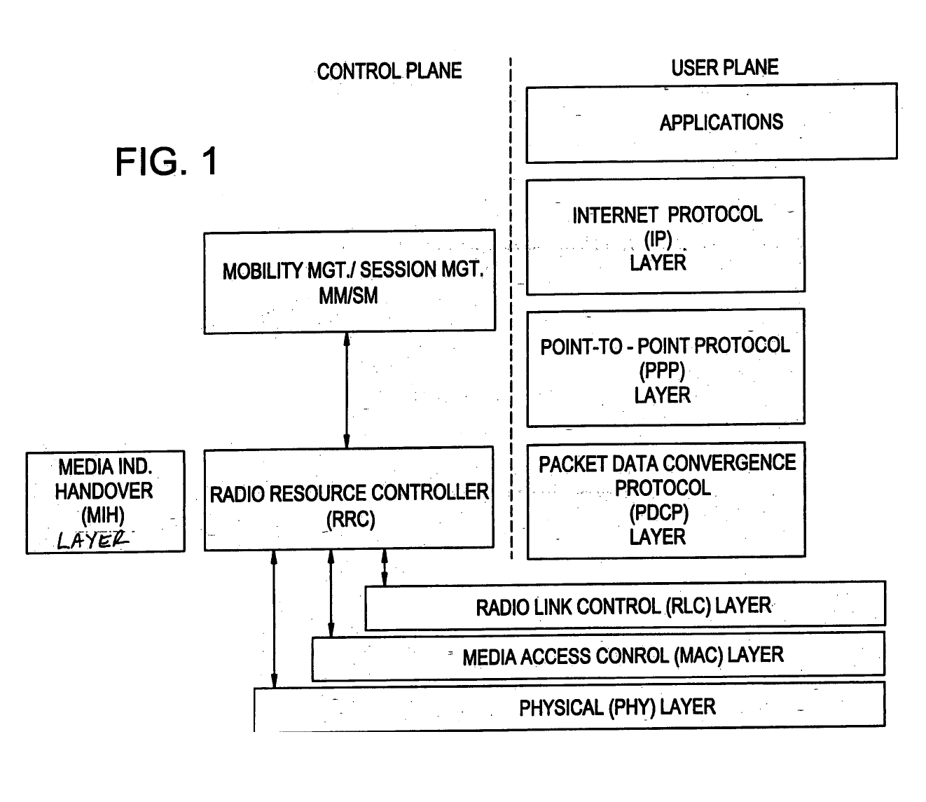

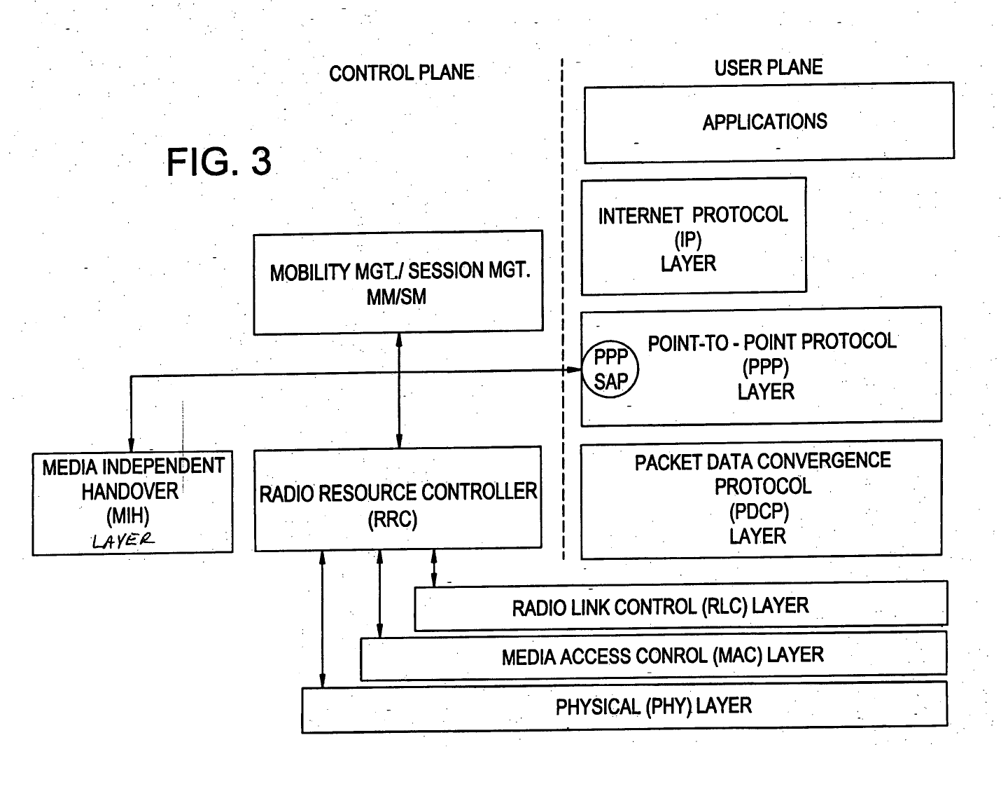

FIG. 3 illustrates an example of the architecture of FIG. 1 that has been modified according to an embodiment of the present invention. As shown, FIG. 3 is the same as FIG. 1, except that the PPP layer includes a service access point (SAP) for communicating with the MIH. Namely, FIG. 3 illustrates a scenario where PPP triggers are sent to the MIH using a PPP SAP (Service Access Point). In this embodiment, triggers may be sent from the PPP layer within a standard 3GPP mobile node (typically referred to as user equipment or UE) to the MIH layer. It will be understood that FIG. 3 is merely an example, and other architectures are possible. For example, the MIH may be incorporated into the 3GPP architecture without necessarily being 802.21 compliant.

Also, while FIG. 3 illustrates the mobile node side, this architecture may also be used at the network side. For example, the PPP layer may reside at the gateway GPRS support node (GGSN), and the MIH layer within the 3G network may be distributed across the various components of the 3G network such as the Node_B, the RNC (radio network controller) and the GGSN.

Within the UE, PPP triggers may be sent to the MIH layer within the UE. At the other PPP end-point, given that the GGSN terminates PPP sessions, PPP triggers are expected to be sent to the MIH component that resides on the GGSN.

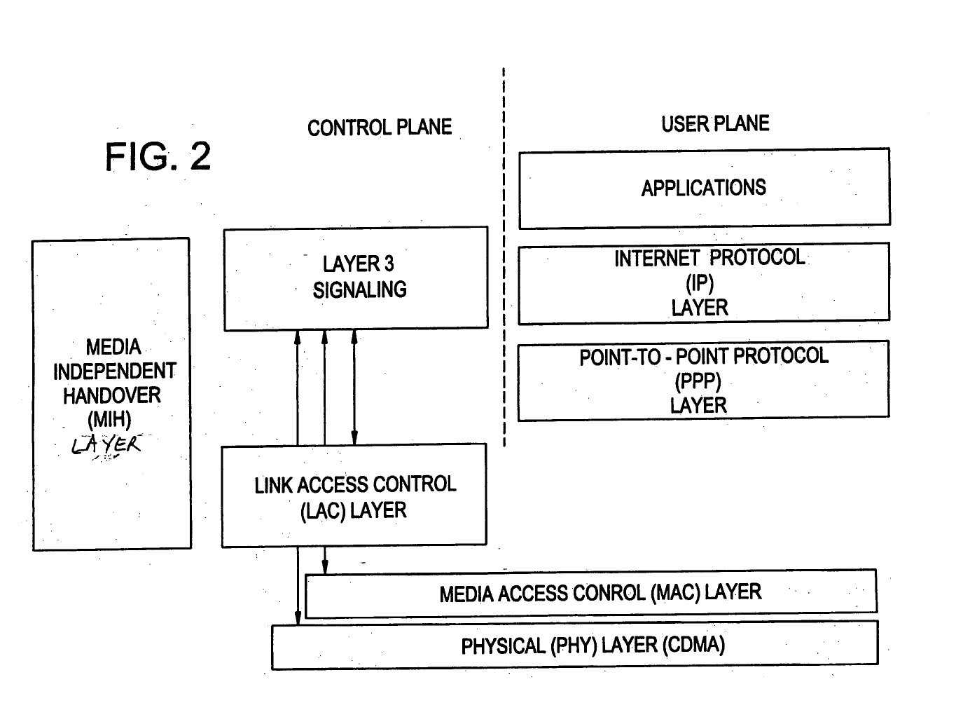

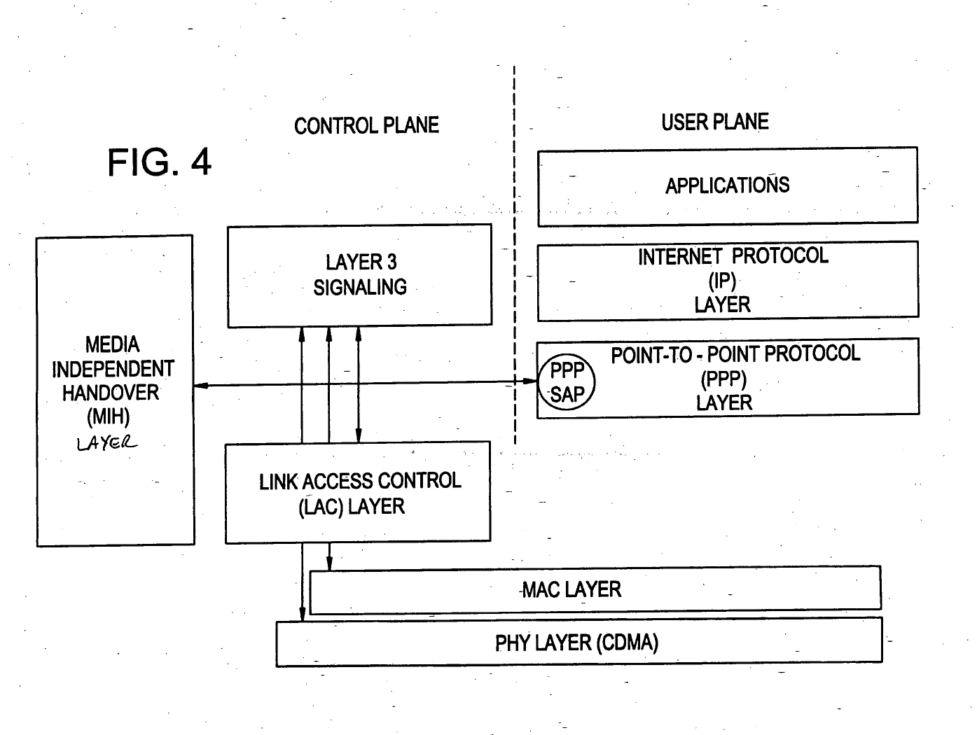

FIG. 4 illustrates an example of the 3GPP2 architecture of FIG. 2 modified according to an embodiment of the present invention. As shown, FIG. 4 is the same as FIG. 2, except that the PPP layer includes a SAP for communicating with the MIH layer. Namely, FIG. 4 illustrates a scenario where PPP triggers are sent to the MIH using a PPP SAP (Service Access Point). In this embodiment, triggers may be sent from the PPP layer within a standard 3GPP2 mobile node (typically referred to as user equipment or mobile station, terminal equipment, mobile terminal, modem, etc.) to the MIH layer. It will be understood that FIG. 4 is merely an example, and other architectures are possible. For example, the MIH may be incorporated into the 3GPP2 architecture without necessarily being 802.21 compliant.

Also, while FIG. 4 illustrates the mobile node side, this architecture may also be used at the network side. For example, the PPP layer may reside at the packet data serving node (PDSN), and the MIH layer within the 3GPP2 network may be distributed across the various components of the network such as the base transceiver station BTS, the base station controller BSC and the PDSN.

Within the mobile node, PPP triggers may be sent to the MIH layer within the mobile node. At the other PPP end-point, given that the PDSN terminates PPP sessions, PPP triggers are expected to be sent to the MIH component that resides in the network for example on the PDSN.

PPP Layer

Before describing the state machine employed by the PPP layer according to the present invention, a general description of the well-known functions performed by the PPP layer in 3GPP and 3GPP2 will be described.

PPP Layer in 3GPP

In a UMTS network standardized by 3GPP, a mobile user may establish a packet connection with packet data networks using a Packet Data Protocol (PDP). The two types for PDP are: PPP (point-to-point protocol) and IP (internet protocol). The PDP type of PPP consists of a PPP protocol stack above a packet data convergence protocol (PDCP) layer in the UE and above GTP in the GGSN. The GGSN may either terminate the PPP protocol or further tunnel PPP PDUs (packet data units) via, for example, a layer 2 transport (L2TP). The discussion here assumes the GGSN terminates the PPP protocol. The PPP provides a mechanism to establish a point-to-point link between the UE and the GGSN and then encapsulate and transport IP packets over this link. The PPP link establishment goes through two phases.

In the first phase, called the Link Control Phase, the establishment of the point-to-point link is negotiated through a sub-protocol called the Link Control Protocol (LCP) where LCP packets are used to exchange link specific parameters between the UE and the GGSN to configure, test and later terminate the data link. During this phase, the user is authenticated using an authentication protocol such as CHAP (Challenge Handshake Authentication Protocol) or PAP (Password Authentication Protocol) or no authentication. CHAP is a three-way handshake protocol where the authenticator (e.g., the GGSN) sends a “challenge” to the UE, which then computes a “response” based on a one-way hash function (which is the secret key) and then returns the response to the GGSN. PAP is a clear-text authentication protocol based on username and password.

In the second phase, called the Network Control Phase, a sub-protocol called the Internet Protocol Control Protocol (IPCP) is used to manage the specific needs of the IP packets that are transported over the PPP link. IPCP allows the GGSN to assign an IP address and DNS server IP address to the UE (in case of Simple-IP) and negotiate the IP header compression algorithm to use on IP packets transported over the PPP link. The header compression algorithms normally used are VJ (Van Jacobson) compression for TCP/IP headers and ROHC (Robust Header Compression) for IP/UDP/RTP. In addition, the Network Control Phase consists of another optional sub-protocol called the CCP (Compression Control Protocol) that is responsible for configuring, enabling, and disabling data compression algorithms on both ends of a PPP link. The compression algorithm is negotiated for each direction. Once these two phases are complete, IP packets are encapsulated and transported over the PPP link. Thus, the four sub-protocols LCP, CHAP/PAP, IPCP and CCP, in that order, make up the different steps in the configuration of a PPP session.

PPP Layer in 3GPP2

Within a CDMA2000 network standardized by 3GPP2, PPP provides a mechanism to establish a point-to-point link between the mobile node and the PDSN and then encapsulate and transport IP packets over this link. The PPP link establishment goes through two phases.

In the first phase, called the Link Control Phase, the establishment of the point-to-point link is negotiated through a sub-protocol called the Link Control Protocol (LCP) where LCP packets are used to exchange link specific parameters between the mobile node and the PDSN to configure, test and later terminate the data link. During this phase, the user is authenticated using an authentication protocol such as CHAP (Challenge Handshake Authentication Protocol) or PAP (Password Authentication Protocol). CHAP is a three-way handshake protocol where the authenticator (e.g., the PDSN) sends a “challenge” to the mobile node, which then computes a “response” based on a one-way hash function (which is the secret key) and then returns the response to the PDSN. PAP is a clear-text authentication protocol based on username and password.

In the second phase, called the Network Control Phase, a sub-protocol called the Internet Protocol Control Protocol (IPCP) is used to manage the specific needs of the IP packets that are transported over the PPP link. IPCP allows the PDSN to assign an IP address and DNS server IP address to the mobile node (in case of Simple-IP) and negotiate the IP header compression algorithm to use on IP packets transported over the PPP link. The header compression algorithms normally used are VJ (Van Jacobson) compression for TCP/IP headers and ROHC (Robust Header Compression) for IP/UDP/RTP. In addition, the Network Control Phase consists of another optional sub-protocol called the CCP (Compression Control Protocol) that is responsible for configuring, enabling, and disabling data compression algorithms on both ends of a PPP link. The compression algorithm is negotiated for each direction. The algorithms used in CDMA2000 standard are MPPC LZS and Deflate. Once these two phases are complete, IP packets are encapsulated and transported over the PPP link. Thus, the four sub-protocols LCP, CHAP/PAP, IPCP and CCP, in that order, make up the different steps in the configuration of a PPP session.

PPP State Machine

As will be appreciated from the above description, the PPP implementation in 3GPP and 3GPP2 are substantially the same. As such, the same mechanism for generating PPP triggers to be sent to the MIH layer may be used in either a 3GPP or 3GPP2 architecture. As described in detail below, PPP triggers are generated, according to a state machine embodiment of the present invention, from the PPP layer and can be sent to the MIH layer during both phases of PPP link establishment. These triggers may also be run on an 802.11, 802.16, etc. network if they use PPPoE to establish PPP links so that they could be used by the MIH layer both on the MN/UE and the Access Point (in the case of 802.11), WiMax base station (in the case of 802.16) or any other network element on these networks. Of the four sub-protocols, triggers generated during LCP, CHAP/PAP and IPCP could potentially be used by the MIH functionality to generate events (e.g., MIH_LCP_LINK_UP. Indication for PPP link coming up or MIH_IPCP_LINK_CLOSED. Indication for PPP down indication) to be passed to the upper and lower layers.

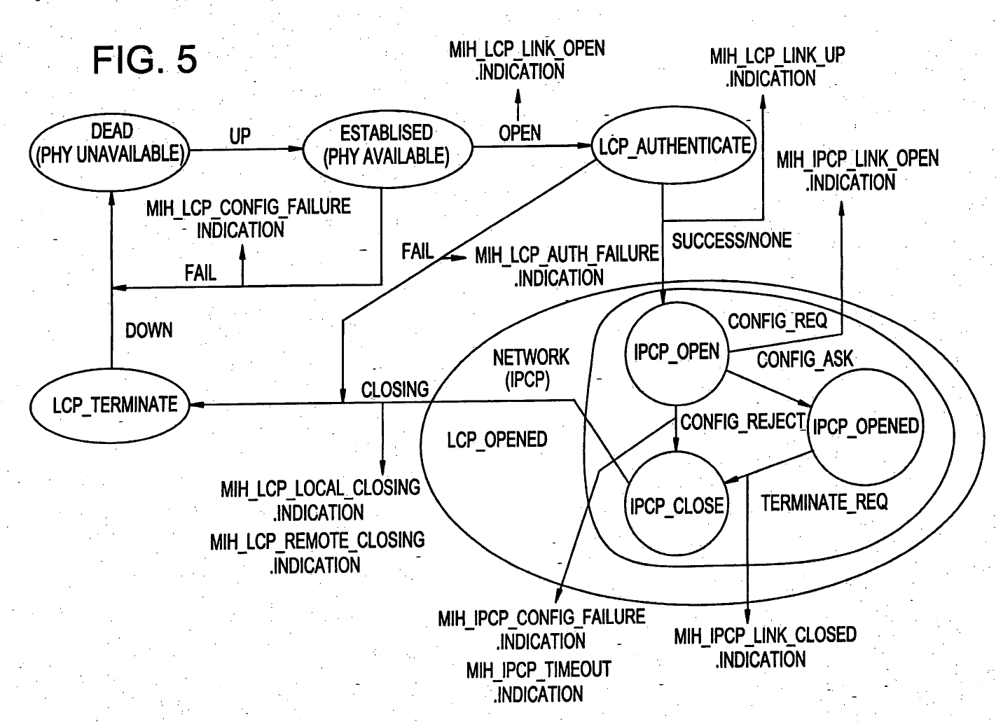

FIG. 5 illustrates a state machine according to which the PPP layer of FIG. 3 or FIG. 4 operates according to an embodiment of the present invention to generate triggers for the MIH layer. In describing the state machine, first the PPP triggers generated during the Link Control Phase will be described and then the triggers generated during the Network Control Phase will be described. Note that the Network Control Phase is a component within the PPP state machine and takes place when the Link Control Protocol has opened the PPP link. The Link Control Phase continues until the link is terminated.

PPP Triggers during Link Control Phase

As shown in the state machine sequence for PPP link negotiation, maintenance and termination, when a PPP link is to be established, the availability of the physical layer is checked and if it is available it is deemed that PPP negotiation may be initiated. This is indicated by the Established state. From this state, the end-points exchange LCP parameters to open the LCP link. If this parameter exchange fails due to some reason, an indicator that the LCP configuration failed MIH_LCP_CONFIG_FAILURE.indication is triggered and sent to the MIH layer, and the PPP link establishment fails. The state machine then returns to the Dead state where the physical layer is unavailable.

If, in the Established state, the LCP parameter exchange is successful, the end-points move into the LCP Authenticate state. During this transition a MIH_LCP_LINK_OPEN.indication trigger is sent to the MIH layer, which indicates that the link is open but authentication (e.g. CHAP/PAP) has yet to be performed. Once the authentication is successful, the state machine moves into the LCP_Opened state. The successful authentication triggers a MIH_LCP_LINK_UP.indication, which indicates that the LCP link is up—namely that the link is open and authentication was successful.

If in the LCP_Authentication state, the authentication is unsuccessful, a MIH_LCP_AUTH_FAILURE.indication trigger is sent to the MIH layer, and the link is terminated by moving the state machine to the LCP_Terminate state. When closing the PPP link, the closing or termination may be initiated by the local end-point or the remote-end point. In either case, when appropriate messages are received, the state machine moves to the LCP_Terminate state. Depending on which end-point initiated the closing of the PPP link, appropriate triggers MIIH_LCP_LOCAL_CLOSING.indication and MIH_LCP_REMOTE_CLOSING.indication are sent to the MIH layer. The MIH_LCP_LOCAL_CLOSING.indication indicates that the end-point running the local PPP state machine closed the LCP link, and the MIH_LCP_REMOTE_CLOSING.indication indicates that the other end-point closed the LCP link. The state machine then moves from the LCP_Terminate state to the Dead state.

In addition, three triggers that are not dependent on state transitions but could happen any time when the state machine is either in the Established, LCP_Authenticate or LCP Opened states are:
MIH_LCP_CARRIER_FAILURE.indication, which indicates a lower layer link failure has taken place and hence the PPP link will be terminated;
MIH_LCP_LINK_QUALTIY_FAILURE.indication, which indicates that the link quality is below a configured threshold (this does not necessarily mean that PPP link should be terminated); and
MIH_LCP_TIMEOUT_FAILURE.indication, which indicates that the PPP link will be terminated because of some time-out (possibly because an expected message does not arrive before the expiration of a timer).

PPP Triggers during Network Control Phase

Within the LCP_Opened state, during the Network Control Phase, the sub-protocol of interest is the IPCP. The (sub) state machine for IPCP is shown within the LCP Opened state in FIG. 5. From the IPCP Open state, if the IPCP parameter configuration is successful, the state machine moves to the IPCP_Opened state and the trigger MIH_IPCP_LINK_OPEN.indication is generated and sent to the MIH layer. The MIH_IPCP_LINK_OPEN.indication trigger indicates that the IPCP link is open. If the parameter configuration is unsuccessful, the state machine moves to the IpCP_Close state and the trigger MIIH_IPCP_CONFIG_FAILURE.indication is generated and sent to the MIH layer. The MIH_IPCP_CONFIG_FAILURE.indication trigger indicates that the IPCP configuration failed. If the IPCP link is closed normally, the state machine moves from the IPCP_Opened state to the IPCP_Closed state and the trigger MIIH_IPCP_LINK_CLOSED.indication, indicating normal closure of the IPCP link, is generated and sent to the MIH layer. In addition, when IPCP parameters are being exchanged, if there is a time-out event (e.g., a timer expires before an expected message is received), a MIH_IPCP_TIMEOUT.indication, indicating this situation, is generated and sent to the MIH layer. In this situation, the state machine moves to the IPCP_Closed state.

When the IPCP link closes, the state machine then moves from the LCP_Opened state to the LCP_Terminate state, and the appropriate one of the MIH_LCP_LOCAL_CLOSING.indication and MIH_LCP_REMOTE_CLOSING.indication are sent to the MIH layer as described in detail above.

### Additional Example 3GPP and 3GPP2 Architectures and Phy/MAC Triggers

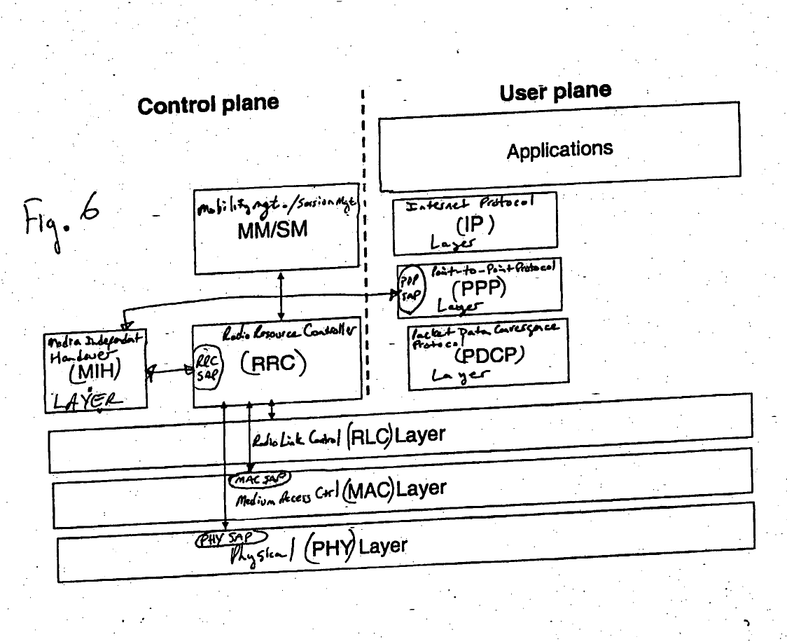

FIG. 6 illustrates another example of the architecture of FIG. 1 that has been modified according to a further embodiment of the present invention. As shown, FIG. 6 is the same as FIG. 3, except that the physical (Phy or PHY) layer includes a service access point (SAP) for communicating with the radio resource controller (RRC), the MAC layer includes a SAP for communicating with the RRC, and the RRC includes a SAP for communicating with the MIH. Namely, FIG. 6 illustrates a scenario where PPP triggers are sent to the MIH using a PPP SAP as in the embodiment of FIG. 3, but further includes sending information (e.g., triggers, etc.) from the MAC and Phy layers to the RRC layer, which may then forward this information to the MIH. Furthermore, the SAPs may be used to carry information (e.g., triggers, directives, etc.) from the MIH to the RRC that are, for example, for providing triggers or directives to control the PHY and/or MAC layers.

In an alternative of this embodiment, the PPP SAP may be eliminated and/or the PPP triggers may be eliminated. In another alternative of this embodiment, the PHY SAP and MAC SAP may send information directly to the MIH layer and the MIH layer may send information directly to the PHY and/or MAC layers.

The PPP triggers are sent in the same manner described above with respect to FIGS. 3 and 4.

The MAC and Phy layers communicate data link and physical link information (e.g., triggers) to the RRC via the respective MAC SAP and Phy SAP, or may communicate directly with the MIH. For example, the MAC layer and Phy layers communicate respective link state information such as whether the data link is up, down, going down, etc., or whether the physical link is up, down, going down, etc. As other examples, the Phy and MAC layers communicate layer link quality information. For example, the Phy layer may communicate the signal strength of a received signal at the Phy layer, a signal-to-noise ratio of a received signal at the Phy layer, etc.; and the MAC layer may communicated the bit error rate of the data link, packet error rate of the data link, etc.

The following is a non-exhaustive list of triggers that the RRC can send to the MIH via the RRC SAP based on the data and physical link information or, for example, triggers.
3GPP-Link-Up: This trigger specifies that the wireless physical link and data link are up. This trigger should be sent from the RRC to the MIH after the RRC determines that both the physical and data link are up; for example, based on respective triggers from the MAC and Phy layers.
3GPP-Link-Down: This trigger specifies that the link is down. This trigger may be sent from the RRC to the MIH layer after the RRC determines that either the data link or the physical link is down; for example, based on respective triggers from the MAC and Phy layers.
3GPP-Link-Going-Down: This trigger specifies that the link is going down in the near future. This trigger should be based on whether either the data link or the physical link is going down.
3GPP-Link-Signal-Strength: This trigger indicates the signal strength at the physical layer; for example, based on the RRC receiving this information from the Phy layer as part of the Phy SAP.
3GPP-Link-SNR: This trigger indicates the signal-to-noise ratio at the physical layer; for example, based on the RRC receiving this information from the Phy layer as part of the Phy SAP.

The following is a non-exhaustive list of triggers that the MIH may send to the RRC layer.
3GPP-Link-Disconnect: This trigger indicates to the RRC that directives should be sent to Phy and/or MAC layers to disconnect existing connection to the network (if generated at the terminal) or to the terminal (if generated within the network).
3GPP-Link-Connect: This trigger indicates to the RRC that directives should be sent to Phy and/or MAC layers to initiate a connection to the network (if generated at the terminal) or to the terminal (if generated within the network).
3GPP-Measure-Link-Signal-Strength: This trigger indicates to the RRC that directives should be sent to Phy layer to initiate signal strength measurement. The measured values will be sent back using the 3GPP-Link-Signal-Strength trigger.
3GPP-Measure-Link-SNR: This trigger indicates to the RRC that directives should be sent to Phy layer to initiate signal strength measurement. The measured values will be sent back using the 3GPP-Link-SNR trigger.
3GPP-Indicate-Threshold-Value-Measure: This trigger indicates to the RRC that directives should be sent to the Phy layer to indicate a threshold value for the signal strength or the SNR above or below which indication should be sent up from the Phy layer to the MIH through the LAC (using the 3GPP-Link-Signal-Strength and 3GPP-Link-SNR triggers).

The above defined triggers may be local triggers (that is, local to the UE or local to the network).

In the case of the MIH layer at the UE, for uplink triggers, the Phy and MAC SAPs communicate to the RRC, for example, on the UE, which in turn uses the 3GPP-RRC-SAP defined above to communicate triggers to the MIH layer, again on the UE. Similarly, for the downlink triggers, the MIH will communicate with the RRC which in turn will use the 3GPP-RRC-SAP to send directives to the Phy and MAC layers. That is, the Phy and MAC SAPs defined as per the 3GPP standard as well as the 3GPP-RRC-SAP communicate locally on the control plane within the UE; however, the present invention is not limited to this.

It will be understood that FIG. 6 is merely an example, and other architectures are possible. For example, the MIH functionality may be incorporated into the 3GPP architecture without necessarily being 802.21 compliant.

Also, while FIG. 6 illustrates the mobile node side, this architecture may also be used at the network side. For example, the PPP layer may reside at the gateway GPRS support node (GGSN), and the MIH layer within the 3G network may be distributed across the various components of the 3G network such as the Node_B, the RNC (radio network controller) and the GGSN. For example, it is expected that within the network, the physical link and data link are with the Node_B whereas the RRC may be at the RNC. This means, the Phy SAP and MAC SAP would communicate information to the RRC across the Radio-Access Network (RAN) from the Node_B to the RNC. It should also be noted that on the network side, link specific triggers would mean that these triggers would be generated at the RRC and passed onto the MIH layer at the RNC on a per UE basis. The MIH layer at a RNC would thus gather information about the link status of the UEs controlled by the RNC.

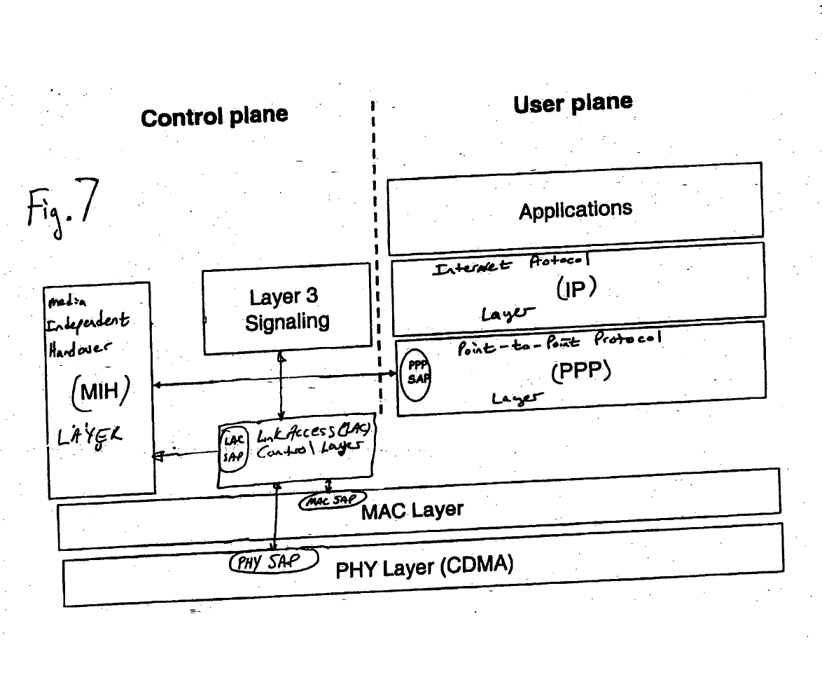

FIG. 7 illustrates an example of the 3GPP2 architecture of FIG. 2 modified according to an embodiment of the present invention. As shown, FIG. 7 is the same as FIG. 4, except that the physical layer includes a service access point (SAP) for communicating with the link access layer (LAC), the MAC layer includes a SAP for communicating with the LAC, and the LAC includes a SAP for communicating with the MIH. Namely, FIG. 7 illustrates a scenario where PPP triggers are sent to the MIH using a PPP SAP as in the embodiment of FIG. 4, but further includes sending information (e.g., triggers) from the MAC and Phy layers to the LAC layer, which may then send information to the MIH. In this embodiment, the information may be sent within a standard 3GPP2 mobile node (typically referred to as user equipment or UE) to the MIH layer. Furthermore, the SAPs may be used to carry information (e.g., triggers, directives, etc.) from the MIH to the LAC that provide, for example, directives or triggers to control the PHY and/or MAC layers.

In an alternative of this embodiment, the PPP SAP may be eliminated and/or the PPP triggers may be eliminated. In another alternative embodiment, the PHY SAP and MAC SAP may send information directly to the MIH layer and the MIH layer may send information directly to the PHY and/or MAC layers.

The PPP triggers are sent in the same manner described above with respect to FIGS. 3 and 4.

The MAC and Phy layers communicate data link and physical link information (e.g., triggers) to the LAC via the respective MAC SAP and Phy SAP, or communicate directly with the MIH. For example, the MAC layer and Phy layers communicate respective link state information such as whether the data link is up, down, going down, etc., or whether the physical link is up, down, going down, etc. As other examples, the Phy and MAC layers communicate physical and data link quality information. For example, the Phy layer may communicate the signal strength of a received signal at the Phy layer, a signal-to-noise ratio of a received signal at the Phy layer, etc. The MAC layer may, for example, communicate data link quality attributes, bit error rate, packet error rate, load conditions, etc.

The following is a non-exhaustive list of triggers that the LAC sends to the MIH via the LAC SAP based on the MAC and Phy information or triggers.
3GPP2-Link-Up: This trigger specifies that the link is up. This trigger should be sent from the LAC to the MIH layer after the LAC determines that both the data link and physical link are up; for example, based on respective triggers. from the MAC and Phy layers.
3GPP2-Link-Down: This trigger specifies that the link is down. This trigger may be sent from the LAC to the MIH layer after the LAC determined that either the data link or physical link is down; for example, based on respective triggers from the MAC and Phy layers.
3GPP2-Link-Going-Down: This trigger specifies that the link is going down in the near future. This trigger should be based on the fact that either the data link or physical link is going down.
3GPP2-Link-Signal-Strength: This trigger indicates the signal strength at the physical layer; for example, based on the LAC receiving this information from the Phy layer as part of the Phy SAP.
3GPP2-Link-SNR: This trigger indicates the signal-to-noise ratio at the physical layer; for example, based on the LAC receiving this information from the Phy layer as part of the Phy SAP.

The following is a non-exhaustive list of triggers that the MIH may send to the LAC layer.
3GPP2-Link-Disconnect: This trigger indicates to the LAC that directives should be sent to Phy and/or MAC layers to disconnect existing connection to the network (if generated at the terminal) or to the terminal (if generated within the network).
3GPP2-Link-Connect: This trigger indicates to the LAC that directives should be sent to Phy and/or MAC layers to initiate a connection to the network (if generated at the terminal) or to the terminal (if generated within the network).
3GPP2-Measure-Link-Signal-Strength: This trigger indicates to the LAC that directives should be sent to Phy layer to initiate signal strength measurement. The measured values will be sent back using the 3GPP2-Link-Signal-Strength trigger.
3GPP2-Measure-Link-SNR: This trigger indicates to the LAC that directives should be sent to Phy layer to initiate signal strength measurement. The measured values will be sent back using the 3GPP2-Link-SNR trigger.
3GPP2-Indicate-Threshold-Value-Measure: This trigger indicates to the LAC that directives should be sent to the Phy layer to indicate a threshold value for the signal strength or the SNR above or below which indication should be sent up from the Phy layer to the MIH through the LAC (using the 3GPP2-Link-Signal-Strength and 3GPP2-Link-SNR triggers).

The above defined triggers are local triggers (that is, local to the terminal or local to the network).

In the case of the MIH layer at the UE, for the uplink triggers, the Phy and MAC SAPs communicate to the LAC, for example, on the UE, which in turn uses the 3GPP2-LAC-SAP defined above to communicate triggers to the MIH layer, again on the UE. Similarly, for the downlink triggers, the MIH will communicate with the LAC which in turn will use the 3GPP2-LAC-SAP to send directives to the Phy and MAC layers. That is, the Phy and MAC SAPs defined as per the 3GPP2 standard as well as the 3GPP2-LAC-SAP communicate locally on the control plane within the UE; however, the present invention is not limited to this.

It will be understood that FIG. 7 is merely an example, and other architectures are possible. For example, MIH concepts like information, triggers and commands may be incorporated into the 3GPP2 architecture without necessarily being 802.21 compliant.

Also, while FIG. 7 illustrates the mobile node side, this architecture may also be used at the network side. For example, the PPP layer may reside at the packet data serving node (PDSN), and the MIH layer within the 3GPP2 network may be distributed across the various components of the network such as the base transceiver station BTS, the base station controller BSC and the PDSN. For example, the Phy may be at the BTS (Base Transceiver Station) whereas the MAC and the LAC may be at the BSC. This means, the Phy SAP would communicate information to the LAC across the Radio-Access Network (RAN) from the BTS to the BSC, the MAC SAP would communicate locally on the BSC to the LAC and the 3GPP2-LAC-SAP defined above would also be local to the BSC as the MIH resides on the BSC. It should also be noted that on the network side, link specific triggers would mean that these triggers would be generated at the LAC and passed onto the MIH at the BSC on a per UE basis. The MIH layer at a BSC would thus gather information about the link status of the UEs controlled by the BSC.

### CONCLUSION

The PPP triggers generated according to the present invention provide the MIH layer with link layer information that may be used to more efficiently and expeditiously provide media independent handover information and triggers. For example, when handing over from a first technology to a second, different technology, the MIH_LCP_LINK_OPEN.indication will notify the MIH layer that the new link has been established and will be up once authentication takes place. The MIH layer may react to this triggers by sending appropriate handover preparation messages or command messages to the upper and lower layers. Once the MIH_LCP_LINK_UP.indication is received, the MIH layer may initiate handover or send instructions to effect handover. Alternatively, the MIH_LCP_AUTH_FAILURE.indication trigger may be used by the MIH layer to prevent handover to a link that can not be authorized by the authenticator. This could prevent call drop events.

With respect to RRC and/or LAC layer triggers, these triggers assist in upper layer (MM/SM or layer 3) hand over performance. Namely, at these higher layers, mobility is not optimized for, for example, real time applications. Detection of mobile (e.g., UE) movement at the upper layer is slow. The Phy, MAC and RRC or LAC triggers expedite mobility detection. For example, the Link-Down trigger may indicate that the UE has moved from the coverage area of the current Node_B. Also, the Link-Signal-Strength and Link-SNR triggers may provide information to judge that a Phy and/or MAC link is going to go down. For example, if the signal strength decreases over time, this may indicate that the UE is moving out of the Node_B's coverage area and the link will be going down.

The invention being thus described, it will be obvious that the same may be varied in many ways. Such variations are not to be regarded as a departure from the invention, and all such modifications are intended to be included within the scope of the invention.

We claim:

1. A method, comprising:
generating at least one of data link and physical link information at a respective one of a medium access control, MAC, layer and a physical layer, the data link information being one of data link state information and data link quality information, and the physical layer information being one of physical link state information and physical link quality information; and
sending information to a media independent handover, MIH, layer based on the generated information.

2. The method of claim 1, wherein the generating step generates data link information at the MAC layer providing data link state information.

3. The method of claim 2, wherein the data link state information indicates the data link is up.

4. The method of claim 2, wherein the data link state information indicates the data link is down.

5. The method of claim 2, wherein the data link state information indicates the data link is going down.

6. The method of claim 1, wherein the generating step generates data link information at the MAC layer providing data link quality information.

7. The method of claim 6, wherein the data link quality information is a bit-error rate of the data link.

8. The method of claim 6, wherein the data link quality information is a packet-error rate of the data link.

9. The method of claim 6, wherein the data link quality information is load conditions of the data link.

10. The method of claim 1, wherein the generating step generates physical link information at the physical layer providing physical link state information.

11. The method of claim 10, wherein the physical link state information indicates the physical link is up.

12. The method of claim 10, wherein the physical link state information indicates the physical link is down.

13. The method of claim 10, wherein the physical link state information indicates the physical link is going down.

14. The method of claim 1, wherein the generating step generates physical link information at the physical layer providing physical link quality information.

15. The method of claim 14, wherein the physical link quality information is a signal strength of a received signal.

16. The method of claim 14, wherein the physical link quality information is a signal-to-noise ratio of a received signal.

17. The method of claim 1, wherein the sending step sends information to the MIH layer via a radio resource controller, RRC.

18. The method of claim 17, wherein the sending step sends information via a service access point, SAP, at one of the MAC layer and physical layer for communicating with the RRC and via a SAP at the RRC for communicating with the MIH layer.

19. The method of claim 1, wherein the sending step sends information to the MIH layer via a link access layer, LAC.

20. The method of claim 19, wherein the sending step sends information via a service access point, SAP, at one of the MAC layer and physical layer for communicating with the LAC and via a SAP at the LAC for communicating with the MIH layer.

21. The method of claim 1, wherein the sending step sends information via a service access point, SAP, at one of the MAC layer and physical layer for communicating with the MIH layer.

22. A method, comprising:
sending information from a media independent handover, MIH, layer for providing at least one of a trigger and a directive to at least one of a physical layer and a medium access control layer, MAC.
